(19) United States
(12) Patent Application Publication
(10) Pub. No.: US 2014/0195297 A1
(43) Pub. Date: Jul. 10, 2014

(54) ANALYSIS OF USAGE PATTERNS AND UPGRADE RECOMMENDATIONS

(71) Applicant: INTERNATIONAL BUSINESS MACHINES CORPORATION, (US)

(72) Inventors: Tamer E. Abuelsaad, Poughkeepsie, NY (US); Gregory J. Boss, Saginaw, MI (US); Clifford A. Pickover, Yorktown Heights, NY (US); Randy A. Rendahl, Raleigh, NC (US)

(73) Assignee: INTERNATIONAL BUSINESS MACHINES CORPORATION, Armonk, NY (US)

(21) Appl. No.: 13/734,142

(22) Filed: Jan. 4, 2013

(51) Int. Cl. G06Q 10/06

(52) U.S. Cl. CPC G06Q 10/0635
USPC 705/7.28

(57) ABSTRACT

An approach is provided for analyzing usage patterns of computing devices and providing upgrade recommendations. The approach is implemented in a computer infrastructure having computer executable code on a computer readable storage medium having programming instructions operable to: monitor usage on one or more electronic devices; and recommend upgraded functionality on the one or more devices based on the monitored usage based on a risk assessment allocation on selected functionality associated with an upgrade for the one or more electronic devices.

### TECHNICAL FIELD

The present invention generally relates to computing systems, and more particularly, to systems and methods for analyzing usage patterns of computing devices and providing upgrade recommendations.

### BACKGROUND

Devices often vary in core functionality, both in the available core capabilities and in the quality of those capabilities that are available (both based on service provider quality and device quality). Software applications often have many different functions and features, and also vary in quality and functionality.

As devices continue to be ever more ubiquitous and social/collaborative technology continues to improve, there will be a spike in the number of implementations of resource pooling/sharing across devices. Collaborative resource borrowing can be costly to a given consumer. In most cases, it is more cost effective to possess a device with the needed capabilities and appropriate quality level. This includes the proper hardware and software components.

An opportune time for making a decision about what constitutes the ideal device for a user occurs at the upgrade or new purchase time. However, in many instances, a consumer does not make a reasoned decision as to what might be an ideal device. Instead, anecdotal evidence, emotions and advice from the service provider, friends and colleagues are usually used to decide upcoming purchases.

### SUMMARY

In an aspect of the invention, a method is implemented in a computer infrastructure having computer executable code tangibly embodied on a computer readable storage medium having programming instructions operable to monitor usage on one or more electronic devices and recommend upgraded functionality on the one or more devices based on the monitored usage and based on a risk assessment allocation on selected functionality associated with an upgrade for the one or more electronic devices.

In an aspect of the invention, a system is implemented in hardware. The system comprises a central service server. The central service server comprises: a primary administration interface which registers devices or requests and analyzes device recommendations; a usage and device database which stores information about registered devices and/or account information, along with usage history pushed across a network from one or more devices; and a central recommendation component which utilizes consumer usage on the one or more devices and matches the usage information to built-in or web based definitions of available devices, hardware components, software components and/or any related functions for recommended use and/or purchase by the user.

In an aspect of the invention, a computer program product comprises a computer usable storage medium having readable program code embodied in the storage medium. The computer program product includes at least one component operable to: register a user device which includes a device identification; confirm the registration; collect data from the user device through a configuration agent resident on the user device when a feature or function of the user device is activated, wherein the collecting of the data includes periodically connecting and uploading a captured action with basic metrics including duration, time, location, and user; and provide a risk assessed recommendation of an upgrade based on the collected data.

In an aspect of the invention, a method of deploying a system for recommending upgrades comprises providing a computer infrastructure, being operable to: store information about registered devices and/or account information, along with usage history pushed across a network from one or more devices; and utilize consumer usage on the one or more devices and match the usage information to built-in or web based definitions of available devices, hardware components, software components and/or any related functions for recommended use and/or purchase by a user of at least one of the registered devices.

In an aspect of the invention, a computer system for recommending upgrades comprises a CPU, a computer readable memory and a computer readable storage media. The system further comprises first program instructions to compile device inventory. The system further comprises second program instructions to compile inventory usage data. The system further comprises third program instructions to analyze the inventory usage data and make a risk assessed recommendation for upgrading to at least one of another device, hardware component and software component using a filtering and prioritized listing process. The first, second and third program instructions are stored on the computer readable storage media for execution by the CPU via the computer readable memory.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 is an illustrative environment for implementing steps in accordance with aspects of the present invention;

FIG. 2 shows a method and system of data collection in accordance with aspects of the present invention;

FIG. 3 shows an enterprise system implementing aspects of the present invention;

FIG. 4 shows a primary set-up process between a central service and one or more devices, in accordance with aspects of the present invention;

FIG. 5 shows an alternative set-up process in accordance with aspects of the present invention;

FIG. 6 shows an ongoing collection process in accordance with aspects of the present invention; and

FIG. 7 shows a process flow for recommendation analysis in accordance with aspects of the present invention.

### DETAILED DESCRIPTION

The present invention generally relates to computing systems, and more particularly, to systems and methods for analyzing usage patterns of computing devices and providing upgrade recommendations and risk assessments. More specifically, aspects of the present invention provide a user an optimized, objective recommendation on upgrading a consumer electronic device (e.g., cellular telephone, tablet, or even a vehicle, etc.). Aspects of present invention also provide a risk assessment concerning the implementation or non-implementation of providing certain hardware components, software components and/or related functionality during the upgrade recommendation process. As used herein, the term device refers to any electronic device such as, for example, cellular telephone, consumer electronics, devices embedded within vehicles, or any computing apparatus, etc.

As should be understood by those of ordinary skill in the art, the selection of cellular telephones or other smart devices available during the renewal process, or from a competitive service provider, is quite broad, covering a wide range of capabilities and levels of quality for those capabilities. Though price may be a key factor in determining upgrades for such device during the renewal process, there is often no reliable way for the user to determine the most appropriate device that fits the user's habits and/or usage. The present invention solves this problem by providing access to usage statistics of the various device functions that the user has utilized over time. In some cases, the usage is shown in volume (number of uses) and frequency.

Using this information, the user can identify the most used functions, the functions not used at all, and the approximate cost associated with functions. In this way, a recommendation component of the present invention can prioritize for the user a set of available device options based on function. This prioritized list can be sort by price or other criteria to choose the most effective recommended option. The systems and methods of the present invention, in embodiments, exist as a mobile “app”, which can recommend the ideal device for the user in accordance with his/her usage habits.

In particular embodiments, the systems and methods of the present invention track the component or function-level usage statistics of a device (e.g., GPS, MP3, camera, accelerometers, 3G usage, 4G usage, battery usage, etc.) over time. In further implementations, the systems and methods of the present invention also track software application usage, over time. Usage of non-primary devices can also be tracked by the systems and methods of the present invention (e.g., what services a user may request from a friend's cellular telephone, etc.). In implementation, an analytics component uses the usage history information to provide recommendations on future buying or upgrading decisions (e.g., generally to replace/upgrade the device or software). Thus, by analyzing user patterns and usages, the systems and methods of the present invention can objectively determine which features are used most often, which incur the most costs, which features are the most desired, etc., and using this information, recommend upgrade and/or replacement devices, software, applications, etc. In embodiments, the present invention can also analyze available upgrade options and, using this upgrade information, recommend upgrade(s) which most closely match the user's needs based on cost, usage, etc.

Aspects of present invention can thus analyze usage data collected, taking into account whether the function was provided by the local device or accessed on a remote device in order to make device upgrade or purchase recommendation(s) using a risk-management component when making decisions about alternative and complementary device suggestions. Accordingly, in embodiments, the systems and methods of the present invention can: (i) analyze tracked function usage data, and (ii) recommend an optimal (or likely to be desirable) device based on such features as, e.g., function use, and an assessment of risk associated with not having such functions. The present invention can also use an automated trigger to crowd-sourced information in order to increase confidence associated with such recommendations.

In embodiments, the analytics component and/or related systems, functions, etc. can be resident on the user's device (local device), another device (remote device) and/or provided by a third party service provider. That is, the analytics component and/or related systems, functions, etc. can be resident on a local device (e.g., cellular telephone, tablet or other smart device), resident directly on a user's device (e.g., cellular telephone, tablet or other smart device), or on a remote device (another cellular telephone not being directly used to provide value to the user), or a third party service provider which is provided through an opt-in service.

### System Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

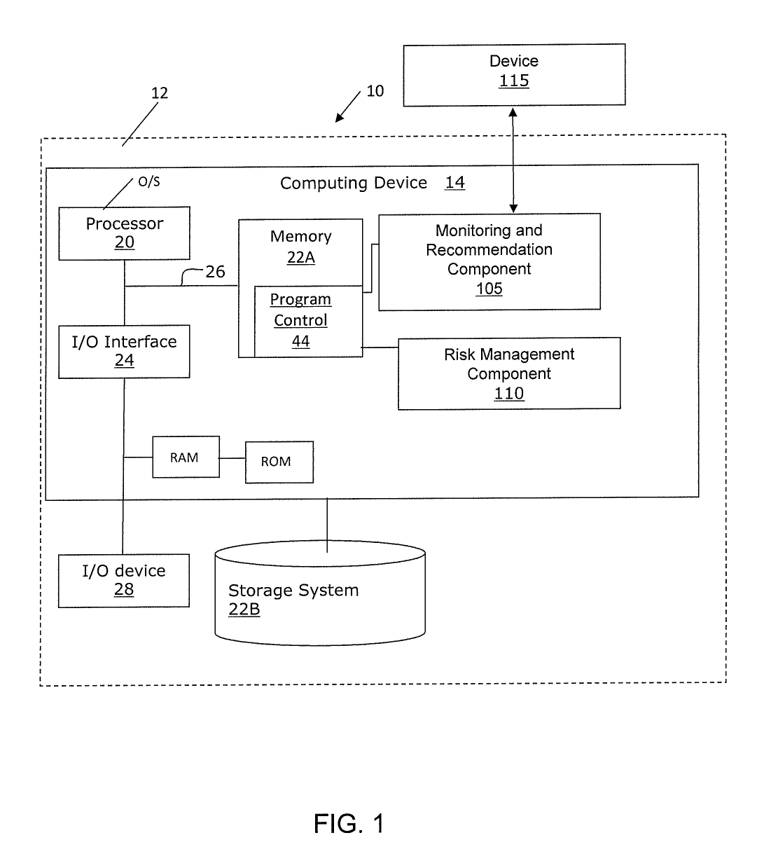

FIG. 1 shows an illustrative environment 10 for managing the processes in accordance with the invention. To this extent, the environment 10 includes a server or other computing system 12 that can perform the processes described herein. In particular, the server 12 includes a computing device 14. The computing device 14 can be resident on a network infrastructure or computing device of a third party service provider (any of which is generally represented in FIG. 1).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with the external I/O device/resource 28 and the storage system 22B. For example, the I/O device 28 can comprise any device that enables an individual to interact with the computing device 14 (e.g., user interface) or any device that enables the computing device 14 to communicate with one or more other computing devices using any type of communications link. The external I/O device/resource 28 may be for example, a handheld device, PDA, handset, keyboard etc.

In general, the processor 20 executes computer program code (e.g., program control 44), which can be stored in the memory 22A and/or storage system 22B. Moreover, in accordance with aspects of the invention, the program control 44 controls a monitoring and recommendation component 105 and a risk management component 110, e.g., the processes described herein. The monitoring and recommendation component 105 and the risk management component 110 can be implemented as one or more program code in the program control 44 stored in memory 22A as separate or combined modules. Additionally, the monitoring and recommendation component 105 and the risk management component 110 may be implemented as separate dedicated processors or a single or several processors to provide the function of these tools. While executing the computer program code, the processor 20 can read and/or write data to/from memory 22A, storage system 22B, and/or I/O interface 24. The program code executes the processes of the invention. The bus 26 provides a communications link between each of the components in the computing device 14.

The monitoring and recommendation component 105 and the risk management component 110 may be provided by a third-party service provider, which may implement a standard interface to monitor a diverse collection of hardware components, software components and/or related functions. For example, the monitoring and recommendation component 105 and the risk management component 110 can be provided on a computing device 12 provided by the service provider and accessed by the user device 115. Alternatively, the monitoring and recommendation component 105 and the risk management component 110 may be customized for a particular piece of software or set of devices. For example, the monitoring and recommendation component 105 and the risk management component 110 can be provided as an “app”, for different smart devices. Alternatively, any combination of the above is also contemplated by the present invention.

In embodiments, the monitoring and recommendation component 105 is configured to monitor a user's use of a device, including, for example, the implementation and use of hardware components, software components, and/or any related functionality thereof, generally shown at reference numeral 115. The monitoring and recommendation component 105 can then use this information to make recommendations about upgrades and/or installation and/or purchases of features in the same device or upgrading to a new device. These recommendations can be made to either a user of a local device or a remote device (providing functionality to the local device, by use of hardware and/or software components and/or related functionality).

By way of example, in embodiments, the monitoring and recommendation component 105 can monitor the level of component usage by component type, function, software, etc. of the local device or the remote device (as requested by the local device). More specifically, the monitoring and recommendation component 105 can monitor the level usage of any device, including, for example, hardware components, software components, and/or any related functionality thereof. By way of illustration and by use of non-limiting examples, the monitoring can include any of the following, amongst others:
(i) feature usage, e.g., GPS, MP3 or other hardware device;
(ii) user impatience (e.g., selecting an icon several times);
(iii) software usage, e.g., pinging back and forth between more than one software package, suggesting that one program with more features may be useful; and/or
(iv) application usage associated with, e.g., different applications, functionality, software components and/or hardware components.

In additional embodiments, the monitoring and recommendation component 105 can monitor the level of component usage by component type, function, software, etc., whether such component usage is provided on the local device or requested to be performed on a remote device. In the latter scenario, the monitoring and recommendation component 105 can monitor any shared applications, components, hardware, software, etc., amongst different devices. That is, the monitoring can include, for example, usage metrics of any device, including, for example, hardware components, software components, and/or any related functionality thereof, on either the local device or a remote device. This latter feature can be provided by monitoring requests by the local device 115 or querying the remote device.

Additionally, in embodiments, the monitoring and recommendation component 105 can determine device quality and performance of the local device or the remote device. This can be done through service quality queries or comparing to a set of known metrics. By way of example, it is possible to monitor the quality of service or performance of any device, including, for example, hardware components, software components, and/or any related functionality thereof, on the remote device, as it is being uploaded or used by the local device. By way of illustration, the monitoring and recommendation component 105 can query the remote device to determine the features requested by the local device, e.g., resolution of camera on the remote device, type of version of software it is using to implement a requested function (e.g., editing package it is using to edit a photo, etc.), etc. In this way, by querying the remote device, the monitoring and recommendation component 105 can determine the functionality, components, etc., and quality thereof on the remote device.

By inference, the monitoring and recommendation component 105 can also determine which features are not provided on the local device, e.g., hardware or software components and/or its related functionality requested to be performed on the remote device. This detailed data may be used to determine the specific device or device type that was providing remote services. This may be used when a noticeable improvement is recognized by the user and they want to understand what facilitated the improvement or an alternate device they might want to use for the same function.

In further embodiments, the monitoring and recommendation component 105 can take an inventory of all hardware and software components and any related functionality provided on the local device 115. This inventory may include expiration information, in addition to the most current versions of the hardware and software components and any related functionality installed on the local device. The monitoring and recommendation component 105 can also determine the latest versions of hardware and software components and any related functionality which may be capable of installation on the local device by querying service providers, software application providers, etc. for latest version information.

In more specific embodiments, usage data can be aggregated over time by the monitoring and recommendation component 105 to provide distribution of usage over history. The usage date, e.g., history data, may be available for off-loading to analytics or working with in a local application. Generally, though, as described in greater detail below, the usage data may be used to analyze the user's behavior to see where resource consumption is coming from or to facilitate improved selection of replacement devices, or upgrading of hardware components, software components and/or related functionality.

In the case of the user's device providing or requesting a local function to or from a remote user, the detailed data can be accessed and summarized for reconciliation of any financial or resource sharing agreement. For example, the monitoring and recommendation component 105 can provide both the user of the local device and the user of the remote device financial benefits/costs for sharing hardware components, software components, and/or any related functionality. By way of illustration, the local device can be provided with the cost of using the hardware components, software components, and/or any related functionality of the remote device; whereas, the remote device can be provided with the cost benefit of providing such usage.

In embodiments, the monitoring and recommendation component 105 can use any of the above noted information, and compare such information to the hardware and software components and/or any related functionality resident on the local device or remote device, to determine whether upgrades are necessary or warranted. The upgrades can be for example, recommendations of new or upgraded devices, hardware components, software components and/or functionality thereof. In embodiments, the upgrades may be recommended to be installed on the local device and/or remote device or the purchase of a new device with upgraded features thereon, based on such factors including, but not limited to:
(i) whether certain hardware components, software components, and/or any related functionality thereof are already installed on the user's device;
(ii) the usage history of the device, including, for example, hardware components, software components, and/or any related functionality thereof;
(iii) whether certain hardware and software components and/or any related functionality have been requested by the local device to be performed on a remote device (or vice versa);
(iv) the expiration date of any service contract of the device and/or expiration date of, for example, hardware components, software components, and/or any related functionality thereof already installed on the device;
(v) the cost of a new device, including, for example, hardware components, software components, and/or any related functionality thereof; and/or
(vi) any financial gains achieved by either the user of the local device or remote device, by requesting or providing services to be performed.

In embodiments, the user has the option to request the financial gains (being a provider of remote services) to be part of the device recommendation process. Similarly, the user can opt to exclude any financial gains during the recommendation process, as the user may no longer want to share with others or earn any financial gains. The user can also be provided with a list of upgraded hardware and software components and any and all related functionality resident on the local device and their related costs. These and other criteria can then be used by the user to determine whether such an upgrade is warranted.

In embodiments, the monitoring and recommendation component 105 can provide recommendations to the user through many different mechanisms. These mechanisms include, for example, email, pop-up windows, messages, instant messages (e.g., via an interface to the preferred user's instant-message system, etc.) or specific requests by the user (e.g., through a push button or other request). For a subscription fee, the monitoring and recommendation component 105 can acquire additional features, updates, accessibility features, etc., for inclusions into the recommendations.

The risk-management component 110, on the other hand, determines a risk of the user not having a certain device, hardware component, software component and/or related functionality. The risk-management component 110 can use a weighting factor depending on different criteria, such as weights being provided to the need to have higher quality applications. In an example of use, if a user uses a feature 10 times a month, and a new device has the feature but with decreased human factors, this may be determined to be low risk. However, if the user uses a feature 100 times a month, and a new device does not have this feature, this may be determined a high risk of not having such a feature on a new device. The assessment of risk, and also the assessment of features to recommend, may be known with a degree of confidence “C”.

In further embodiments, the risk-management component 110 may assess risk of not having such device, hardware component, software component and/or related functionality by requesting further input from a crowd sourcing component, e.g., blogs, experts, bulletin boards, etc. For example, if C<threshold, then a request is automatically sent to a crowd-sourcing component to increase the confidence level, e.g., request further information from such crowd-sourcing components. By aggregating such additional data, the risk-management component 110 can determine the quality, performance, or need of a certain device, hardware component, software component and/or related functionality based on the above noted criteria.

The computing device 14 can comprise any general purpose computing article of manufacture capable of executing computer program code installed thereon (e.g., a personal computer, server, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computing infrastructure 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

### Data Collection

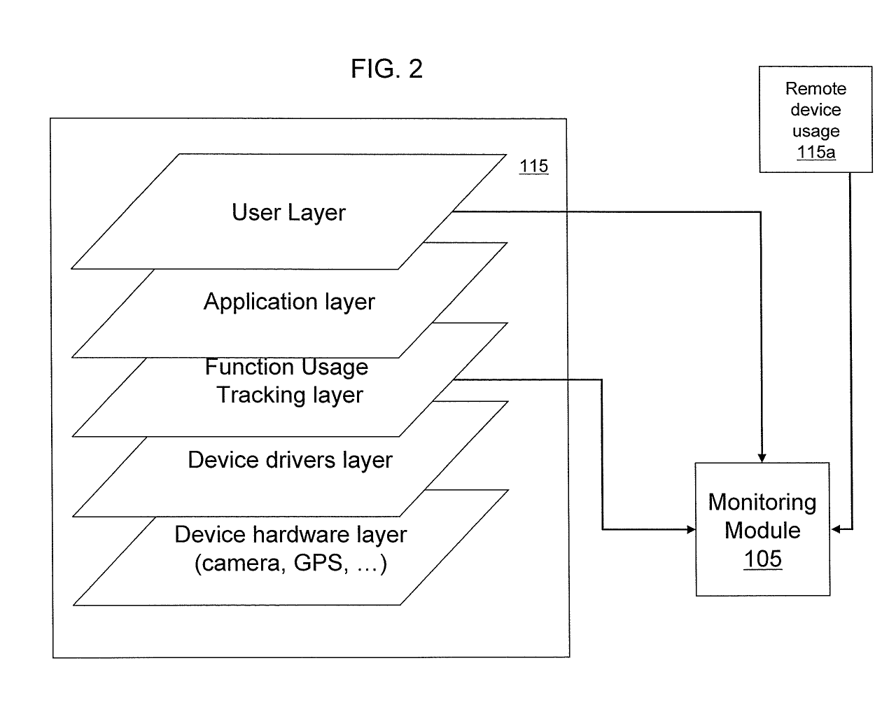

FIG. 2 shows a method and system of data collection in accordance with aspects of the present invention. In particular, FIG. 2 shows a device 115 which can be, for example, a local device (or a remote device). In embodiments, the device 115 includes the following abstraction layers: user layer; application layer; function usage tracking layer; device drivers' layer; and device hardware layer, e.g., GPS, camera, etc. FIG. 2 also shows the monitoring and recommendation component 105 and a remote device 115a.

In embodiments, the user layer identifies the user and other information of the device, e.g., device ID (MAC ID), O/S information, etc. The information from the user layer can be provided to the monitoring and recommendation component 105. The application layer includes software and other application information residing on the device 115.

The function usage tracking layer captures usage information that is used in the monitoring and recommendation component 105, e.g., provides information that is used in the analytics. For example, the function usage tracking layer can query the device 115 to determine resident hardware and software and other functionality of the device 115. The function usage tracking layer tracks information such as, for example, but not limited to:
(i) device usage, e.g., camera clicks, sharing of information, activation of a device (e.g., tuning into a wifi zone, 4G, Bluetooth, GPS, etc.);
(ii) pressing a physical button on a device (e.g., taking a picture);
(iii) activating a system software function (e.g., syncing email or other data);
(iv) using a certain capability/function (e.g., gyro, compass, accelerometer, CPU, memory, storage, etc.);
(v) requesting device functionality and/or components of the remote device 115a by the local device 115; and/or
(vi) habits of the user, during implementation of any combination of (i)-(v).

This information can be used to populate a table, saved on the storage device 22B of FIG. 1, for example. In embodiments, the table can be saved on the device 115 or other storage system of a service provider, for example. In embodiments, the function usage tracking layer can populate the table with regard to the usage of the hardware component, software component and/or other functionality of the device 115, as outlined in the above examples. This can include, for example, duration of usage, time of request, type of request, requesting user information, device information from either or both of the local device 115 and the remote device 115a, location of the request, amongst other information. For example, the function usage tracking layer can provide a hash mark or other notation in the table for each usage of a hardware component, a software component or other functionality of the device 115, or other information.

The device driver layer is a low level layer that includes drivers for hardware and software components. The device hardware layer is a low level layer that includes the hardware devices such as, for example, GPS, camera, etc. In embodiments, the function usage tracking layer and/or the monitoring and recommendation component 105 can inventory the device driver layer and the device hardware layer, and provide such information to the saved table. This information can be used to compare against other devices or to determine whether such drivers and/or hardware are needed on the device, or whether certain recommendations are warranted.

Optionally or in addition, the device 115 may provide additional mechanisms for a user to specify the importance of a feature, whether it be a hardware component, software component and/or related functionality. For example, to signify such importance, a user may select a button (e.g., a physical button or a GUI button) or simply press a button with more force during activation of a certain feature. Other mechanisms for specifying the importance of a feature may be through voice input and recognition or through gestures (e.g., including gestures on a touch screen or with a pointing device).

As an example embodiment, consider an application, e.g., paint program, which receives a touch-screen gesture (e.g., a spiral gesture) to indicate a strong need and liking of a feature. Alternately, consider a mobile device that uses an application (e.g., “app”) that makes use of any of: activating a radio (e.g., turning on wifi/4G/Bluetooth®/GPS); pressing a physical button (e.g., taking a picture); activating a system software function (e.g., syncing data/email/etc.); or using a capability (e.g., gyro, compass, accelerometer, CPU, Memory, Storage, etc.). While using the “app”, the user may indicate a strong need for such “app”, and a component-checking unit (CCU) determines what underlying features the “app” uses on the device. In embodiments, the CCU can be, for example, the function usage tracking layer of the device 115 or the monitoring and recommendation component 105. If the CCU is part of the function usage tracking layer, it can then transmit this information for use, as needed, to the monitoring and recommendation component 105 as an aid to determining future recommendations. For example, if the user gesture indicates that a feature is important, this can be considered when automating the sending of recommendations in the future.

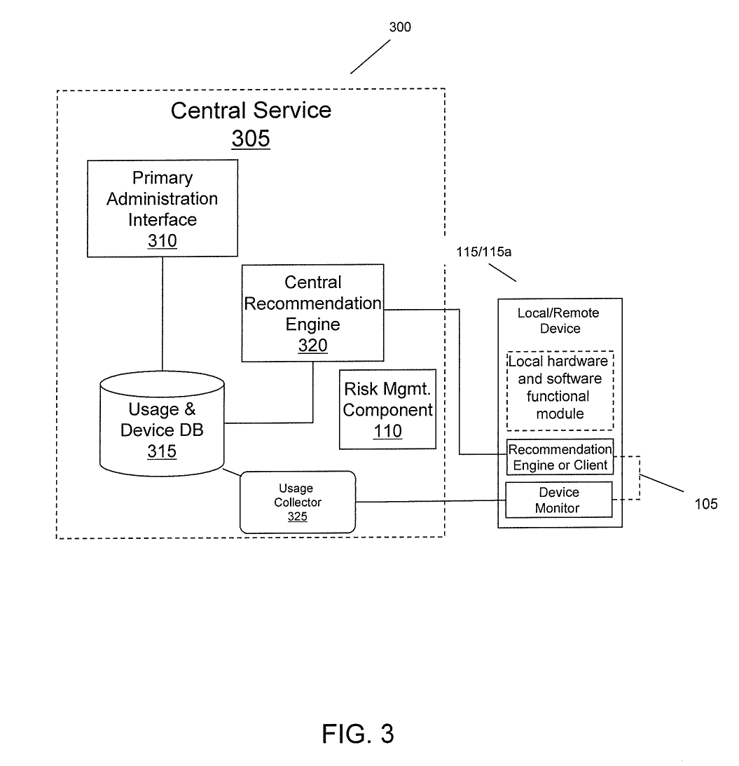

FIG. 3 shows an enterprise system implementing aspects of the present invention. In embodiments, the enterprise system 300 includes a central service 305 (e.g., server). In embodiments, the central service 305 may be implemented as a server or service, for example, a SaaS (Software as a Service). By using the central service 305 it is now possible to push information from the monitoring component of one or more devices to a central server for commercial level analysis, e.g., more robust analysis of information. In implementation, and advantageously, the central service 305 can receive information from many different devices, and collate this information for analytical use for each of the separate devices. The central service 305 can also poll information from other sources, including retrieving information from other service providers, e.g., functionality of devices, hardware components and/or software components, as well as request additional information from crowd sourcing to provide a more robust analysis of information and, hence, a more granular and reliable recommendation to the user.

The central service 305 includes a primary administration interface 310, which registers devices or requests and analyzes device recommendations. The central service 305 also includes a usage and device database 315. The usage and device database 315 can be, for example, equivalent to the storage system 22B of FIG. 1. In embodiments, the usage and device database 315 stores information about registered devices and/or account information, along with usage history pushed across the network from the devices 115/115a. The usage history can be obtained from a usage collector 325 and stored in the usage and device database 315. The central service 305 can also provide the registration and account information of each of the registered devices to the usage and device database 315.

The central service 305 also includes a central recommendation component 320 and a central risk management component 110. In this and other implementations, the central recommendation component 320 utilizes the consumer usage on the one or more devices and matches this usage information to built-in or web based definitions of available devices, hardware components, software components and/or any related functions for recommended use and/or purchase by the user. By way of more specific example, the central recommendation component 320 can receive information from the device 115/115a, by way of the monitoring and recommendation component 105 resident on the device 115/115a, and use this information to search the internet or registered service providers for recommendations of devices, hardware components, software components and/or related functionality. In this way, the monitoring and recommendation component 105 of any device can provide usage information as discussed herein, and the central recommendation component 320 can then use such information to provide recommendations for upgrades of devices, hardware components, software components and/or related functionality. The risk management component 110, on the other hand, provides key input on importance of feature function inclusion, and can also be polled.

FIG. 3 further shows the device, which is connected to the central service 305. In embodiments, the device can be either the local device 115 or the remote device 115a. The device 115/115a can include local hardware and software, and the monitoring and recommendation component 105. The monitoring and recommendation component 105 can be device specific, and can include a local recommendation engine. The local recommendation engine can provide recommendations, much like that described with regard to FIG. 1. In further implementations, the recommendations engine can be a simple client to access the central recommendation component 320. The monitoring and recommendation component 105 can also include a device specific agent which collects usage and device data to store locally and share with the central service 305.

### Flow Diagram

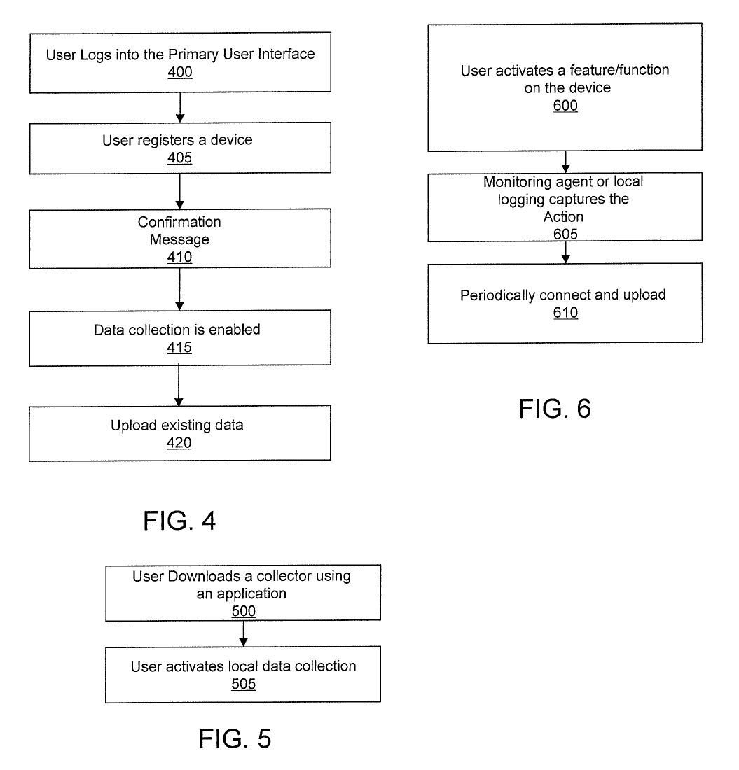

FIGS. 4-7 show exemplary flows for performing aspects of the present invention. The steps of FIGS. 4-7 may be implemented in the environment of FIG. 1 or the central service of FIG. 3, for example. The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, the invention can take the form of a computer program product accessible from a computer-usable or computer-readable medium providing program code for use by or in connection with a computer or any instruction execution system. The software and/or computer program product can be implemented in the environment of FIG. 1 or central service of FIG. 3. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

FIG. 4 depicts an exemplary flow diagram for a process in accordance with aspects of the present invention. In particular, the flow diagram of FIG. 4 shows a primary set-up process between a central service and one or more devices. At step 400, the user logs into the primary user interface, e.g., the interface shown in FIG. 3. At step 405, the user registers a device. This may include, for example, using the device IP address, telephone number or other communication address of the device. At step 410, the central usage collector can send a confirmation message to the device and then await a confirmation from the device. This, in essence, can be a handshake between the central service and the device. Once the confirmation is established, at step 415, data collection is enabled through a configuration agent downloaded onto the device, for example. In step 420, if data collection was already active due to the use of an alternative set-up shown in FIG. 5, for example, existing data is uploaded to the central service data store.

FIG. 5 shows an alternative flow diagram of a primary set-up in accordance with aspects of the present invention. In FIG. 5, at step 500, a user downloads a collector agent, e.g., monitoring component, on the device from the central service. At step 505, the user activates the collector agent, which then begins collection of usage data. This usage data can then be provided to the central service data store, for example, for analysis.

FIG. 6 shows an ongoing collection process in accordance with aspects of the present invention. At step 600, a user activates a feature or function of the device. This may include, for example, by way of non-limiting and non-exhaustive list of activations: (i) a radio (wifi, 4G, GPS, Bluetooth, etc); (ii) device activation (e.g., taking a picture, compass, accelerometer, CPU load, etc); and/or (iii) activating system software (syncing email, notifications, etc). At step 605, the monitoring component, e.g., whether on the central service or on the device, captures the action with basic metrics such as duration, time, location, user, etc. At step 610, when the agent, e.g., monitoring component, is registered to a central service, it will periodically connect and upload such information to the central service. This upload may be time based, number of triggers triggered, or triggered by connection type, among others. During or after the collection process, the process of the present invention can provide a risk assessed recommendation for an upgraded device, feature and/or function thereof.

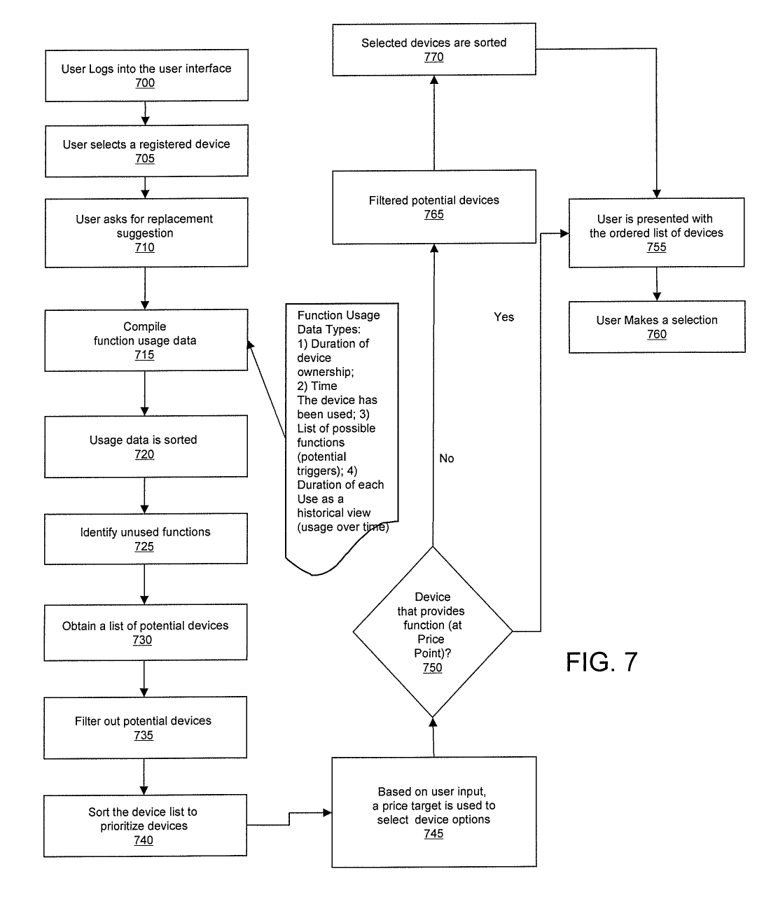

FIG. 7 shows a process flow for recommendation analysis in accordance with aspects of the present invention. Generally, the process flow of the present invention may compile the following elements from data collection:
(i) Time the device has been owned;
(ii) Time the device has been used;
(iii) List of all possible functions in the device;
(iv) Function usage duration;
(v) Function usage frequency; and/or
(vi) Metrics from analysis of “remote” device functions used.

The process flow can also identify the most used functions using one or more of the following metrics:
(i) Usage of function over time, with recent usage weighted higher than past usage;
(ii) Usage of function by geographic location (usage at work versus leisure);
(iii) Function to function dependencies and associations; and/or
(iv) User input based on lifestyle change or context importance.

The process flow can then provide an assessment of risk associated with each function if it will not be recommended or taken into consideration for a device attribute. The process flow of the present invention can also analyze potential new devices by, for example:
(i) Filtering out devices that do not have all (or a majority) of the functions used on the currently used device;
(ii) Increasing the priority of devices with upgraded functions that are used the most by the user (e.g., an improved GPS that can lock on position faster);
(iii) Filtering or lowering the priority of more expensive devices (possibly based on user input); and/or
(iv) Filtering or lowering the priority based on function(s) exclusion risk.

The process flow will then return to the user a prioritized list of the devices.

More specifically, referring to FIG. 7, at step 700, a user logs into the primary user interface. At step 705, the user selects a registered device. At step 710, the user requests recommendations for devices, hardware components, software components, etc. At step 715, the recommendation component compiles the function usage data. This function usage data types include, by way of non-limiting examples:
(i) duration of device ownership;
(ii) time the device has been used;
(iii) list of possible functions (potential triggers); and/or
(iv) duration of each use as a historical view (usage over time), amongst others as already discussed herein.

At step 720, usage data is sorted by all triggering conditions based on function usage and duration. At step 725, the unused functions of the device can be identified. At step 730, a list of potential devices is obtained, which may include a combination of different hardware components, software components and related functionality. At step 735, the processes of the present invention filter out potential devices that do not have all of the features used in the currently used device or, alternatively, features which are used in the currently used device. Other filters are also contemplated by the present invention, as described above.

At step 740, the processes of the present invention sort the device list to prioritize devices with upgraded features (like GPS) when they are high use features in the currently used device. At step 745, based on user input, a price target is used to select device options that most closely match the function usage. As described herein, price input is optional and may simply be a sorting mechanism to highlight cost effective satisfaction of usage patterns.

At step 750, a determination is made as to whether there is a device that provides the required functions. The determination may also take into consideration price point. If there is a device, at step 755, the user is presented with the ordered list of devices (combined list when the price point is missed). At step 760, the user can then make a selection. If no device is available, then at step 765, filtered potential devices are assessed using the prioritized list of features to find the device with the most features for the price point. At step 770, selected devices are sorted by least risk of missing key functions. The system then reverts to step 755.

Alternative options include utilizing a local interface on the device that depends on only the local data. If the local device is configured to push to a central service, the local interface should either suggest the user access the central interface, or provide remote access to the recommendation component of the present invention. Additional steps could utilize queries to user groups or other sources to obtain additional information about potential device quality characteristics for matching usage history to potential devices.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

### Examples of Use

The following scenarios are disclosed to show exemplary illustrations implementing aspects of the present invention. The following scenarios are provided for illustration purposes only, and are not to be considered limiting examples of the present invention. In each of the below scenarios, the systems and methods of the present invention will monitor a user's use of devices, software, and/or components of devices and software. Based on such monitoring, the systems and methods of the present invention make recommendations on future purchases or upgrades (e.g., so that the user will obtain devices or software with useful components and characteristics).

Scenario 1:

Consider a scenario where a user has a long lasting relationship with a mobile phone provider. Without the analytics of the present invention, the user can only base the decision to continue or terminate the relationship based on anecdotal data, perhaps information from others on perceived coverage quality of other providers or indistinct and questionable coverage maps that do not fully represent individual blind spots or spotty coverage on the fringe. As part of the application set on the user's smart phone, the user has enabled a bandwidth pooling application that negotiates data use with other devices when needed. The application has a usage based charging model that the phone can payoff on-demand, much like a data charge on its own network which would be billed for any overage.

In each pooling session, both the local and remote devices track the usage metrics for the bandwidth service being provided by the remote device. The devices reconcile the usage metrics and arrange the electronic payment. The renewal date for the device contract with the current provider is now coming due. The user has been generally satisfied with his smart device, so he expects to simply renew and upgrade the hardware. Before doing that, the user looks at the usage reports of his device so he can decide what model might suit him the best. In this case, the user looks at the data service download subsection and finds that more than 50% of the data downloading is coming from remote devices. Looking at the breakout of that remote usage, the user finds that most of that is due to very low service access quality causing the equivalent of a fail over to a remote pay for use option.

Using that information, the user looks to the provider that was most prominently listed as the remote provider to see what the current coverage models show. Though the user cannot be certain the 50% that his current provider did provide will be covered, the user is now significantly more circumspect in determining his service provider.

Scenario 2:

User 1 has a smart device. User 1 borrows a remote device screen. The recommendation and monitoring component on the device detects this information and it is provided at time of new phone purchase. User 1 has a “recommend device for me” button during his device upgrade process. The system recommends the most suitable phone to User 1 based on the gathered statistics.

Scenario 3:

User 1 has a phone classified as a gaming phone. The recommendation and monitoring component notes that User 1 does not use the gaming capabilities at all. It is time for User 1 to upgrade his mobile device. User 1 has a “recommend device for me” button during his device upgrade process. The system recommends one or more phones that are not of gaming class.

Scenario 4:

A user is using a graphics software package, e.g. paint shop application. The recommendation and monitoring component monitors use of the package and determines those features of highest interest (e.g., the user is always performing touch-ups on photos and so benefits from a package with a variety of features for touch-ups). Based on this monitoring, the recommendation and monitoring component may make suggestions with respect to new software to purchase, new features available for the current product, etc.

Scenario 5:

A user may require an audio editing package for their employment. The recommendation and monitoring component monitors use of the package and determines those features of highest interest (e.g., the user is always performing certain audio edits and so benefits from a package with a variety of features for certain audio edits). Based on this monitoring, the recommendation and monitoring component may make suggestions with respect to: new software to purchase, new features available for the current product, etc. A request may also be automatically sent to experts, bulletin boards, etc. to increase the confidence with respect to a recommended feature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented in a computer infrastructure having computer executable code tangibly embodied on a computer readable storage medium having programming instructions operable to:
monitor usage on one or more electronic devices; and
recommend upgraded functionality on the one or more devices based on the monitored usage and based on a risk assessment allocation on selected functionality associated with an upgrade for the one or more electronic devices.

2. The method of claim 1, wherein the risk assessment allocation provides a risk of not recommending hardware components, software components and/or related functionality during an upgrade recommendation process.

3. The method of claim 1, wherein the upgraded functionality is at least one of a device, hardware components, software components and related functionality and the recommended upgraded functionality is further based on a cost analysis of upgrading to the upgraded functionality.

4. The method of claim 1, further comprising prioritizing a list of recommended upgraded devices based on a statistical analysis of the usage on the one or more electronic devices and a comparison to available devices.

5. The method of claim 4, further comprising calculating a confidence level of the recommend upgraded functionality, which can be refined by information received from crowd sourcing when the confidence level is below a predefined threshold.

6. The method of claim 1, wherein:
the monitoring of the usage comprises at least one of monitoring usage of hardware components, software components, and any related functionality on the one or more electronic devices, over a period of time;
the monitoring of the usage comprises monitoring requests for functionality from a remote device; and
the recommending of the upgraded functionality comprises analyzing usage data collected, taking into account whether the functionality is provided by a local device or accessed on the remote device.

7. The method of claim 6, wherein the monitoring of the usage comprises monitoring any shared application, hardware component and software component amongst different devices.

8. The method of claim 1, wherein:
the monitoring of the usage comprises at least one of:
feature usage;
user impatience;
software usage; and
application usage associated with different applications, functionality, software components and/or hardware components; and
the upgrade is recommended based on at least one of:
the functionality as already installed on the one or more electronic devices;
the usage history of the one or more electronic devices;
functionality requested by a user;
expiration date of any service contract of the one or more devices and/or software components installed on the one or more devices;
cost of a new device; and
financial gains achieved by upgrading to a new device.

9. The method of claim 1, wherein the monitoring of the usage comprises determining device quality and performance of services.

10. The method of claim 1, further comprising taking an inventory of all hardware and software components and any related functionality on the one or more electronic devices, which includes at least one of expiration information and version type of the hardware component and software component.

11. The method of claim 1, further comprising providing recommendations to a device user through email, pop-up windows, messages, instant messages or specific requests by the device user.

12. The method of claim 1, wherein a service provider at least one of creates, maintains, deploys and supports the computer infrastructure.

13. The method of claim 1, wherein steps of claim 1 are provided by a service provider on a subscription, advertising, and/or fee basis.

14. A system implemented in hardware, comprising:
a central service server, comprising
a primary administration interface which registers devices or requests and analyzes device recommendations;
a usage and device database which stores information about registered devices and/or account information, along with usage history pushed across a network from one or more devices; and
a central recommendation component which utilizes consumer usage on the one or more devices and matches the usage information to built-in or web based definitions of available devices, hardware components, software components and/or any related functions for recommended use and/or purchase by the user.

15. The system of claim 14, wherein the central service server further comprises a central risk management component which assesses a risk to a user of not providing certain functionality.

16. The system of claim 15, wherein the central risk management component requests information from crowd sourcing when a confidence level of a calculated risk is below a threshold, such that the crowd sourcing can provide additional risk assessment for refinement of the calculated risk.

17. The system of claim 14, wherein the central recommendation component receives information from the one or more devices and uses the information to search the internet or registered service providers for recommendations of devices, hardware components, software components and/or related functionality.

18. The system of claim 14, wherein the central service server comprises a SaaS (Software as a Service).

19. The system of claim 14, wherein the central service server receives information from many different devices, and collates the received information for analytical use for each of the separate devices.

20. The system of claim 19, wherein the central server service polls information from other sources, including retrieving information from crowd sourcing to provide a reliable recommendation to the user.

21. A computer program product comprising a computer usable storage medium having readable program code embodied in the storage medium, the computer program product includes at least one component operable to:
register a user device which includes device identification;
confirm the registration;
collect data from the user device through a configuration agent resident on the user device when a feature or function of the user device is activated, wherein the collecting of the data includes periodically connecting and uploading a captured action with basic metrics including duration, time, location, and user; and
provide a risk assessed recommendation of an upgrade based on the collected data.

22. The computer program product of claim 21, wherein the at least one component is provided on a user device.

23. A method of deploying a system for recommending upgrades, comprising:
providing a computer infrastructure, being operable to:
store information about registered devices and/or account information, along with usage history pushed across a network from one or more devices; and
utilize consumer usage on the one or more devices and match the usage information to built-in or web based definitions of available devices, hardware components, software components and/or any related functions for recommended use and/or purchase by a user of at least one of the registered devices.

24. The method of claim 23, wherein the computer infrastructure is further operable to provide a risk assessment of not recommending certain functionality for upgrade.

25. A computer system for recommending upgrades, the system comprising:
a CPU, a computer readable memory and a computer readable storage media;
first program instructions to compile device inventory;
second program instructions to compile inventory usage data;
third program instructions to analyze the inventory usage data and make a risk assessed recommendation for upgrading to at least one of another device, hardware component and software component using a filtering and prioritized listing process,
wherein the first, second and third program instructions are stored on the computer readable storage media for execution by the CPU via the computer readable memory.
